(19) United States
(12) Patent Application Publication
(10) Pub. No.: US 2021/0150665 A1
(43) Pub. Date: May 20, 2021

(54) IMAGE PROCESSING METHOD AND DEVICE

(71) Applicant: SZ DJI TECHNOLOGY CO., LTD., Shenzhen (CN)

(72) Inventors: Yan ZHOU, Shenzhen (CN); Xiaozhen ZHENG, Shenzhen (CN)

(21) Appl. No.: 17/162,886

(22) Filed: Jan. 29, 2021

Related U.S. Application Data
(63) Continuation of application No. PCT/CN2018/098105, filed on Aug. 1, 2018.

(51) Int. Cl. G06T 3/00; G06T 3/60; G06T 3/40; G06T 9/00; H04N 19/137; H04N 19/105; H04N 19/159; H04N 19/597

(52) U.S. Cl. CPC G06T 3/0043; G06T 3/60; G06T 3/4038; G06T 9/001; H04N 19/176; H04N 19/105; H04N 19/159; H04N 19/597; H04N 19/137

(57) ABSTRACT

An image processing method includes, for a first region in a first planar image, determining a second region for obtaining the first region, where the second region is a region in a second planar image, the first planar image is obtained by performing mapping on a curved surface image, and the curved surface image is obtained from the second planar image, obtaining a motion vector of the first region at least according to a motion vector of the second region, and encoding the first planar image at least according to the motion vector of the first region.

### CROSS-REFERENCE TO RELATED APPLICATION

This application is a continuation of International Application No. PCT/CN2018/098105, filed Aug. 1, 2018, the entire content of which is incorporated herein by reference.

### TECHNICAL FIELD

The present disclosure relates to the field of image processing, and in particular to an image processing method and device.

### BACKGROUND

In order to reduce the bandwidth occupied by video storage and transmission, video data can be encoded and compressed.

Inter-frame encoding of video encoding uses the information of a reference image to obtain prediction block data. The process includes dividing an image to be coded into several image blocks, and then, for each image block, searching for an image block that best matches the current image block in the reference image as a predicted block. In a motion on a two-dimensional plane, the motion of an object is basically a rigid motion, such as a translation, at the two-dimensional plane. Therefore, global motion vector (GMV) information can be calculated for a region where a search point is located during a motion search process. When a motion search is performed, the search will not start from point (0, 0), but start with the GMV information as a search origin, so that it is easier to search for the predicted block that best matches. Further, due to a limitation of a motion search range, sometimes for some sub-image blocks with drastic motion, it may be impossible to accurately search for the most matching image block as the predicted block. Using GMV technology can avoid such problems, thereby making the results of motion search more accurate and improving the image encoding quality to a certain extent.

However, when a panoramic video is encoded and compressed, because the panoramic image is a curved surface image, when the panoramic image is mapped to a two-dimensional plane for encoding, there is usually some stretching and distortion in order to keep the complete information of the curved surface image. As a result, the motion of the object in the panoramic video may not be a rigid motion, and the GMV information calculated according to this may not be accurate, thus reducing the quality of video encoding.

### SUMMARY

In accordance with the disclosure, there is provided an image processing method including, for a first region in a first planar image, determining a second region for obtaining the first region, where the second region is a region in a second planar image, the first planar image is obtained by performing mapping on a curved surface image, and the curved surface image is obtained from the second planar image, obtaining a motion vector of the first region at least according to a motion vector of the second region, and encoding the first planar image at least according to the motion vector of the first region.

Also in accordance with the disclosure, there is provided an image processing device that includes a processor and a memory storing instructions that, when executed by the processor, cause the processor to, for a first region in a first planar image, determine a second region for obtaining the first region, where the second region is a region in a second planar image, the first planar image is obtained by performing mapping on a curved surface image, and the curved surface image is obtained from at least the second planar image, obtain a motion vector of the first region at least according to a motion vector of the second region, and encode the first planar image at least according to the motion vector of the first region.

### BRIEF DESCRIPTION OF THE DRAWINGS

To more clearly illustrate the technical solution of the present disclosure, the accompanying drawings used in the description of the disclosed embodiments are briefly described below. The drawings described below are merely some embodiments of the present disclosure. Other drawings may be derived from such drawings by a person with ordinary skill in the art without creative efforts.

FIG. 1 is a structural diagram of a technical solution according to an embodiment of the present disclosure.

FIG. 2 is a schematic flowchart of inter-frame encoding according to an embodiment of the present disclosure.

FIG. 3 is a schematic flowchart of an image processing method according to an embodiment of the present disclosure.

FIG. 4 is a schematic flowchart of an image processing method according to an embodiment of the present disclosure.

FIG. 5 is a schematic diagram showing mapping a curved surface image to a planar image according to an embodiment of the present disclosure.

FIG. 6 is a schematic diagram showing mapping a curved surface image to a planar image according to an embodiment of the present disclosure.

FIG. 7 is a schematic diagram showing mapping positions of multiple second regions at a first region.

FIG. 8 is a schematic diagram showing a rotation of a second region due to image stitching according to an embodiment of the present disclosure.

FIG. 9 is a schematic flowchart of an image processing method according to an embodiment of the present disclosure.

FIG. 10 is a schematic block diagram of an image processing device according to an embodiment of the present disclosure.

FIG. 11 is a schematic block diagram of a computer system according to an embodiment of the present disclosure.

### DETAILED DESCRIPTION OF THE EMBODIMENTS

The technical solutions in the embodiments of the present disclosure are described below with reference to the accompanying drawings.

The specific examples in this disclosure are only to assist those skilled in the art to better understand the embodiments of the present disclosure, rather than limiting the scope of the embodiments of the present disclosure.

The formulas in the embodiments of the present disclosure are only examples, and do not limit the scope of the embodiments of the present disclosure. Each formula can be modified, and these modifications should also fall within the scope of the present disclosure.

In various embodiments of the present disclosure, the size of the sequence numbers does not mean that the execution order is sequential. The execution order of each process should be determined by its function and inherent logic and should not apply any limitation to the implementation process in the embodiments of the present disclosure.

The various embodiments described in this disclosure can be implemented individually or in combination, which is not limited in the embodiments of the present disclosure.

Unless otherwise defined, all technical and scientific terms used in the disclosure have the same meaning as commonly understood by those of ordinary skill in the art. The terminology used in the specification of the present disclosure is for the purpose of describing specific embodiments only and is not intended to limit the present disclosure. The term “and/or” used herein includes any suitable combinations of one or more related items listed.

A stitching of a panoramic image refers to a process of generating a larger or even 360 degrees omnidirectional image using partially overlapping planar images obtained by a translation or rotation of a camera. In other words, a set of partial planar images of a given scene are obtained, and then a new view image containing the set of partial planar images, i.e., a panoramic image, is generated by stitching the set of planar images.

During image stitching, multiple planar images can be projected onto a unified space surface in a certain manner, such as a surface of a polyhedron, a cylinder, or a sphere, so that these multiple planar images have a unified space coordinate system. In this unified space, the adjacent images are compared to determine locations of matching regions. The overlapping regions of the images are fused to form a panoramic image.

The panoramic image may include a 360-degree panoramic image. A 360-degree panoramic video usually includes an image with a horizontal viewing angle of 360 degrees (−) 180°˜180° and a vertical viewing angle of 180 degrees (−90°˜90°), which is usually presented in a form of a three-dimensional spherical surface.

A stitched panoramic image can be a curved surface image. In order to facilitate storage and transmission, the curved surface panoramic image can be expanded to obtain a two-dimensional planar panoramic image, which can be encoded and transmitted.

The operation of expanding the curved surface panoramic image to obtain the two-dimensional planar panoramic image can be called mapping.

In some embodiments of the present disclosure, multiple mapping manners may be used to obtain the two-dimensional planar panoramic image. For example, a manner of using a polyhedron or a latitude and longitude map for mapping can be used.

For an expanded two-dimensional planar panoramic image, an encoding and compression system shown in FIG. 1 can be used.

Referring to FIG. 1, a system 100 receives data to be encoded 102, encodes the data to be encoded 102, and generates encoded data 108. Data to be encoded is also referred to as “to-be-encoded data.” For example, the system 100 may receive panoramic video data. In some embodiments, components of the system 100 may be implemented by one or more processors. The processor may be a processor of a computing device or a processor of a mobile device (such as an unmanned aerial vehicle (UAV)). The processor may be any type of processor, which is not limited in the embodiments of the present disclosure. In some embodiments, the processor may include an image signal processor (ISP), an encoder, or the like. The system 100 may also include one or more memories. The memory can be used to store instructions and data, such as computer-executable instructions that implement the technical solutions of the embodiments of the present disclosure, the data to be encoded 102, the encoded data 108, and so on. The memory may be any type of memory, which is not limited in the embodiments of the present disclosure.

Encoding is needed for efficient and/or secure transmission or storage of data. The encoding of the data to be encoded 102 may include data compression, encryption, error correction encoding, format conversion, and the like. For example, compressing multimedia data (such as video or audio) can reduce a number of bits transmitted on the network. Sensitive data, such as financial information and personal identification information, can be encrypted before transmission and storage to protect confidentiality and/or privacy. In order to reduce the bandwidth occupied by video storage and transmission, video data needs to be encoded and compressed.

Any suitable encoding technique can be used to encode the data to be encoded 102. The encoding type depends on the data being encoded and the specific encoding needs.

In some embodiments, the encoder may include one or more different codecs. Each codec may include codes, instructions, or computer programs that implement different encoding algorithms. Based on various factors including a type and/or source of the data to be encoded 102, a receiving entity of the encoded data, available computing resources, a network environment, a business environment, rules and standards, etc., a suitable encoding algorithm can be selected to encode given data to be encoded 102.

For example, the encoder can be configured to encode a series of video frames. A series of processes can be used to encode data in each frame. In some embodiments, an encoding process may include prediction, transformation, quantization, and entropy encoding, etc.

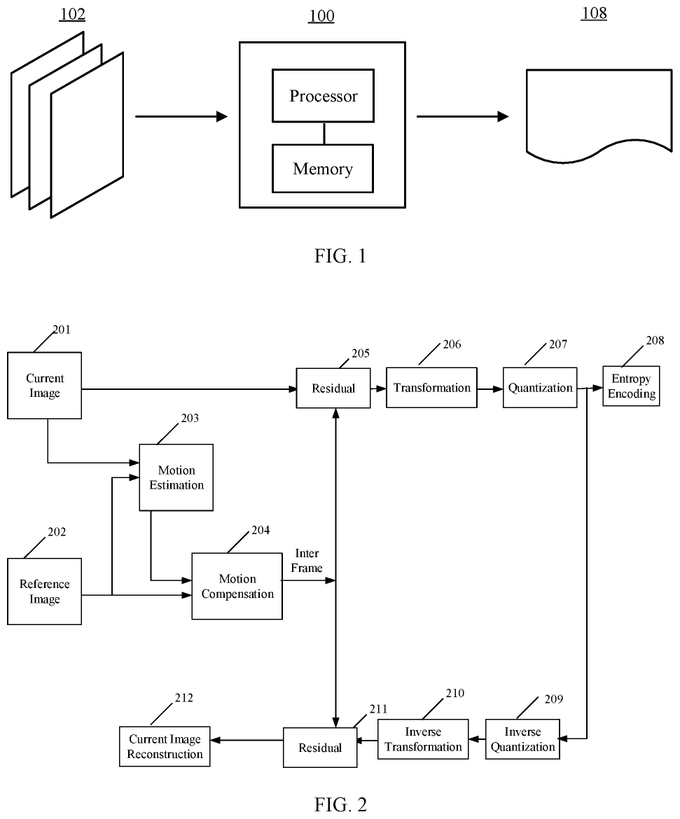

An inter-frame encoding process will be described with reference to FIG. 2 as an example.

At 201, a current image is obtained.

At 202, a reference image is obtained.

At 203, a motion estimation is performed according to the current image and the reference image to obtain a motion vector (MV). During a motion estimation process, the current image can be divided into multiple non-overlapping image blocks, and it is assumed that displacements of all pixels in the image block are the same. For each image block, according to a certain matching criterion, a block most similar to the current image block, i.e., a match block, is found within a specific search range of the reference image, and a relative displacement between the match block and the current image block is calculated as the motion vector.

At 204, a motion compensation is performed based on the motion vector obtained by the motion estimation to obtain an estimation value of the current image block.

At 205, a residual for the current image block is obtained by subtracting the estimation value of the current image block from the current image block, and a residual of the image is obtained by combining the obtained residuals corresponding to various image blocks.

At 206, the residual of the image block is transformed. The residual of the image block is transformed according to a transformation matrix to remove a correlation of the residual of the image block, i.e., to remove redundant information of the image block, therefore the coding efficiency is improved. The transformation of a data block in the image block usually uses a two-dimensional transformation. That is, at an encoding end, the residual information of the data block is multiplied by an N×M transformation matrix and the transposed matrix of the transformation matrix, and transformation coefficients are obtained after the multiplication.

At 207, the transformation coefficients are quantized to obtain quantized coefficients.

At 208, the quantized coefficients are entropy encoded, and finally an entropy-coded bitstream and encoding mode information, such as intra prediction mode and motion vector information, etc., are stored or sent to a decoding end. At the image decoding end, the entropy-coded bitstream is obtained and entropy decoding is performed to obtain the corresponding residuals. A predicted image block corresponding to the image block is obtained based on the decoded motion vector, inter prediction and other information. Then values of various pixels in the current image block are obtained according to the predicted image block and residual of the image block.

At 209, an inverse quantization is performed on a quantization result.

At 210, an inverse transformation is performed on an inverse quantization result.

At 211, a residual is obtained according to an inverse transformation result and a motion compensation result.

At 212, the current image is reconstructed, and the reconstructed current image can be used as a reference image for other images.

During coding, an image can be divided into coding tree units (CTU), and each CTU can include one or more coding units (CU), which is a unit to decide whether to perform intra prediction or inter prediction. Each CU can also be divided into smaller prediction units (PU) and transformation units (TU). PU is a basic unit for prediction operation, and TU is a basic unit for transformation and quantization. The images or image blocks in the processes described above can be any of the various units mentioned here.

At 202, in the process of motion search, advanced motion vector prediction (AMVP) can be used. That is, a correlation of motion vectors in the spatial and time domains is used to establish a candidate predicted motion vector (MV) list for the current image block. The predicted MV is sent to the motion estimation process for a positive pixel motion search and a negative pixel motion search, and an image block that best matches the current PU is found in a motion search range as the predicted block to obtain a final motion vector.

In a two-dimensional motion on a plane, the motion of an object is basically a rigid motion such as a translation at the two-dimensional plane. Therefore, the GMV information can be calculated for a region where a search point is located during a motion search process. When a motion search is performed, the search will not start from a point (0, 0), but start with the GMV information as a search origin, so that it is easier to search for the predicted block that best matches. Further, due to a limitation of the motion search range, sometimes for some image blocks with drastic motion, it may be impossible to accurately search for the most matching image block as the predicted block. Using GMV technology can avoid such problems, thereby making the results of motion search more accurate and improving the image coding quality to a certain extent.

However, when a panoramic image is coded, because the stitched panoramic image is a curved surface image, when the panoramic image is mapped to a two-dimensional plane for encoding, there is usually some stretching and distortion in order to keep the complete information of the curved surface image. As a result, the motion of the object in the panoramic image may not be a rigid motion, and the GMV information calculated according to a mapped two-dimensional plane may not be accurate.

Therefore, a method that can obtain GMV information of a stitched planar image according to GMV information of a planar image before stitching and encode the stitched planar image according to the obtained GMV information is provided according to an embodiment of the present disclosure. An image before stitching is also referred to as a “pre-stitching image.”

The ISP end may process the image before stitching before the panoramic image is stitched to obtain the GMV information of the image before stitching.

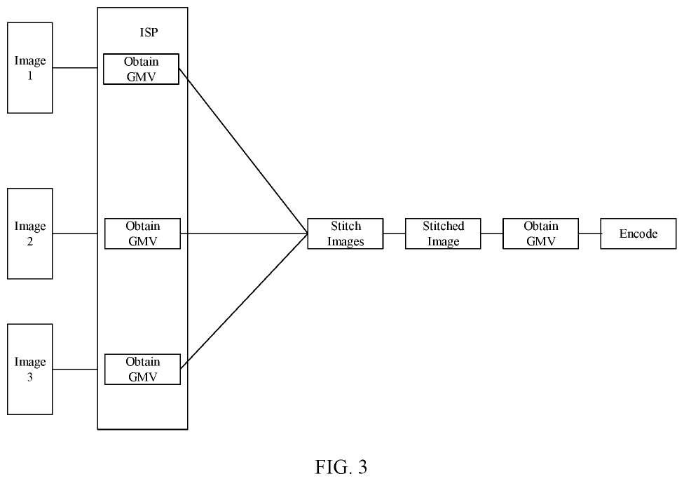

For example, as shown in FIG. 3, GMVs of multiple images (image 1, image 2, and image 3) can be obtained at the ISP end. After the GMVs are obtained, the multiple images are stitched to obtain a stitched image (also called a panoramic image). A GMV of the stitched image is calculated based on the GMVs of the images before stitching, and the calculated GMV is used to encode the stitched image.

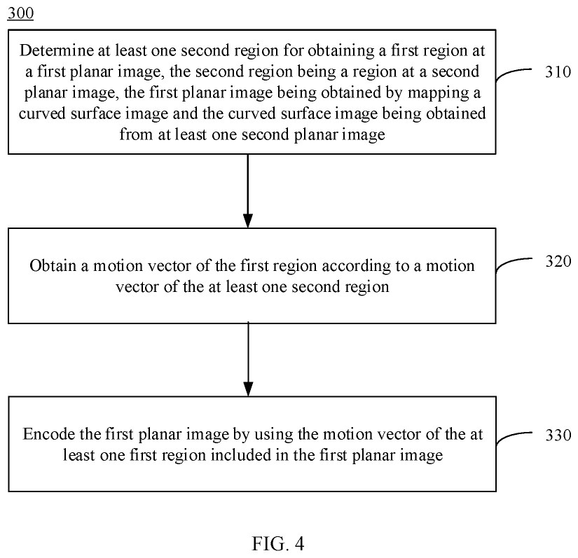

FIG. 4 is a schematic flowchart of an image processing method 300 according to an embodiment of the present disclosure. The method 300 includes at least some of the following content. The following image processing method can be implemented by an image processing device, for example, a panoramic camera, a VR/AR product (such as glasses), a head mounted device (HIVID), or a video encoder. Further, the image processing device can be disposed at a UAV.

At 310, at least one second region for obtaining a first region at a first planar image is determined. The second region is a region at a second planar image. The first planar image is obtained by mapping a curved surface image. The curved surface image is obtained from at least one second planar image.

In some embodiments, the curved surface image is obtained by stitching at least one second planar image. That is, the curved surface image may be a curved panoramic image.

In some embodiments, the first planar image is obtained by mapping the curved surface image to a plurality of polygons on a surface of a polyhedron and expanding the plurality of polygons. The polyhedron may be a hexahedron (for example, a cube), an octahedron or a dodecahedron.

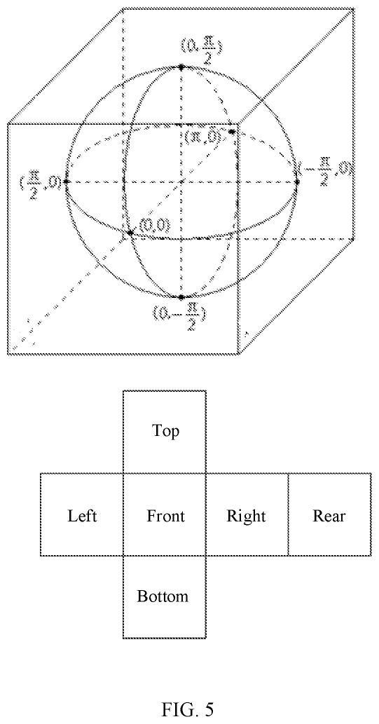

For example, the polyhedron is a cube and the curved surface image is a three-dimensional spherical image. As shown in FIG. 5, the spherical image can be represented by six equal-sized square faces of the cube, and a cross-shaped two-dimensional image is obtained by expanding images mapped onto the six faces of the cube directly according to a spatial relationship.

The cross-shaped two-dimensional image can be directly used as an image to be encoded (also referred to as a “to-be-encoded image”) for encoding, or the cross-shaped two-dimensional image can be integrated into another shape, such as a rectangle, and then the rectangular image can be used as the two-dimensional image to be encoded for encoding.

In some embodiments, the first planar image is obtained by mapping the curved surface image according to a two-dimensional latitude and longitude map.

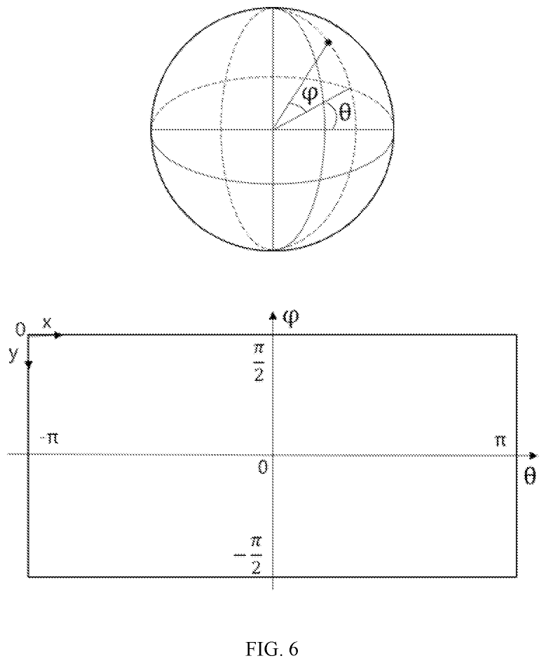

When the latitude and longitude map is used for mapping, the latitude and longitude map represents a two-dimensional planar image obtained by sampling an azimuth angle θ and an elevation angle φ of a complete spherical image, as shown in FIG. 6.

In addition to the mapping methods of polyhedrons and latitude and longitude maps, other mapping mechanisms can also be used to map a curved surface image into a planar image. The mapped planar images can form a planar image video, and the two-dimensional planar image video can be encoded and compressed by using a general video codec standard, such as HEVC/H.265, H.264/AVC, AVS1-P2, AVS2-P2, VP8, or VP9. The two-dimensional planar image video may be obtained through mapping a spherical image video, or may be obtained through mapping a partial spherical image video. The spherical image video or partial spherical image video is usually captured by multiple cameras.

In some embodiments, the first region may include one or more pixels.

In some embodiments, the first planar image may include one or more first regions.

When the first planar image includes a plurality of first regions, shapes of the plurality of first regions or numbers of the pixels included in the plurality of first regions (areas) may be the same or different.

In some embodiment, the second region may include one or more pixels.

In some embodiments, the second planar image may include one or more second regions.

When the second planar image includes a plurality of second regions, shapes of the plurality of second regions or numbers of pixels included in the plurality of second regions (areas) may be the same or different.

In some embodiments, shapes of the first region and the second region or numbers of pixels included in the first region and the second region may be the same or different.

In some embodiments, the first region is obtained by stitching the at least one second region.

In some embodiments, the motion vector of the second region may be generated by an ISP.

In some embodiments, the motion vector is a GMV.

In some embodiments, when the motion vector is a GMV, the first region and the second region may respectively include multiple pixels. In some embodiments, the first region and the second region may be PUs, or image blocks divided in another way, which is not limited in the embodiments of the present disclosure.

To facilitate understanding of this disclosure more clearly, how to determine the at least one second region for obtaining the first region is described as follows.

In an implementation manner, a mapping position at the first planar image for a region included in the second planar image is determined. Among the regions included in the second planar image, a region whose mapping position falls within the first region is determined as the second region. The mapping position mentioned in the embodiments of the present disclosure may be a coordinate.

In some embodiments, each of the second planar images that are stitched to form a curved surface image can be divided into multiple regions, and the first planar image can be divided into multiple regions. Various regions of a second planar image can be mapped onto the first planar image. Thus, when a motion vector of a certain region of the first planar image is calculated, the regions of the second planar image whose mapping positions fall in the certain region of the first planar image can be determined as the second regions.

The second region falling in the first region may refer to that the entire or some of the pixels included in the second region fall in the first region.

In some embodiments, a mapping position at the first planar image for a first pixel in a region included in the second planar image is determined, and a mapping position at the first planer image for the region included in the second planar image is determined according to the mapping position of the first pixel at the first planar image.

The first pixel may include a center pixel of the region, or another pixel of the region. For example, if the region is a square region, the first pixel may include one of pixels at four vertices of the square.

After the mapping positions of one or more first pixels at the first planar image are calculated, the mapping position of the region at the first planar image can be determined according to a shape of the region.

The first pixel may be any pixel in the region included in the second planar image. That is, the mapping positions of various pixels at the second planar image are obtained according to the above-described manner, and used to obtain the mapping position of the region at the first planar image.

In some embodiments, according to a rotation matrix that is used to rotate and stitch the second planar images to obtain the curved surface image, and/or an intrinsic parameter matrix of a camera that shoots the second planar image, the mapping position of the first pixel at the first planar image is determined.

In some embodiments, the intrinsic parameters of the camera may include a focal length of the camera, radial and tangential distortions, etc. The intrinsic parameter matrix K of the camera may be:

$$K = [ \begin{matrix}{f}_{x} & s & {x}_{0} \\ 0 & {f}_{y} & {y}_{0} \\ 0 & 0 & 1\end{matrix} ]$$

where, fₓ and f_{y} are the focal lengths of the camera in the x and y directions, respectively, which are generally equal, x₀ and y₀ are coordinates of a principal point, and s is a skew coefficient of axes.

In some embodiments, when the second planar images are stitched to form the curved surface image, the rotation matrix R and the camera intrinsic parameter matrix K are used during stitching. Therefore, the rotation matrix R and the camera intrinsic parameter matrix K can be used to determine the mapping position of the first pixel at the first planar image.

In some embodiments, the mapping position of the first pixel at the first planar image can be calculated by mapping the coordinates of the first pixel at the second planar image to spherical coordinates and mapping the spherical coordinates to the coordinates at the first planar image. The entire process can be called coordinate transformation.

In some embodiments, according to a homography matrix transformation obtained by using the rotation matrix R and the camera intrinsic parameter matrix K, a correspondence relationship between the first pixel at the second planar image and the pixel at the first planar image can be calculated.

For example, the three-dimensional coordinates of the first pixel at the second planar image are (x, y, z=1), and the coordinates after transformation are (x₁, y₁, z₁). The coordinates after transformation are also referred to as “transformed coordinates.” The transformation refers to a transformation in a coordinate transformation process. Then, the transformed coordinates are mapped to spherical coordinates (U, V, W). The following Formulas 1-4 can be used for the calculation.

$$\begin{matrix}[ \begin{matrix}{x}_{1} \\ {y}_{1} \\ {z}_{1}\end{matrix} ] = R * {K}^{T} [ \begin{matrix}x \\ y \\ z\end{matrix} ] & Formula 1 \\ U = scale * {tan}^{- 1} \frac{{x}_{1}}{{z}_{1}} & Formula 2 \\ W = \frac{{y}_{1}}{\sqrt{{x}_{1}^{2} + {y}_{1}^{2} + {z}_{1}^{2}}} & Formula 3 \\ V = scale * ( π - {cos}^{- 1} W ) & Formula 4\end{matrix}$$

After the spherical coordinates of the first pixel point are calculated, the spherical coordinates can be inversely mapped to the coordinates at the second planar image. In some embodiments, the coordinate transformation is performed to obtain coordinates (x₂ , y₂ , z₂), and then coordinates (x₂ , y₂ , z₂) are mapped to the first planar image to obtain coordinates (x₀, y₀), i.e., the mapping position of the first pixel at the first planar image. The following Formulas 5-10 can be used for the calculation.

$$\begin{matrix}u = \frac{U}{scale} & Formula 5 \\ v = \frac{V}{scale} & Formula 6 \\ {x}_{2} = sin ( π - v ) * sin u & Formula 7 \\ {y}_{2} = cos ( π - v ) & Formula 8 \\ {z}_{2} = sin ( π - v ) * cos u & Formula 9 \\ [ \begin{matrix}{x}_{0} \\ {y}_{0} \\ {z}_{0}\end{matrix} ] = K * {R}^{T} [ \begin{matrix}{x}_{2} \\ {y}_{2} \\ {z}_{2}\end{matrix} ] & Formula 10\end{matrix}$$

where (x₀, y₀, z₀) is obtained through Formula 10. If z₀>0, x₀=x₀/z₀, y₀=y₀/z₀, otherwise, x₀=y₀=−1. In this way, the mapping position (x₀, y₀) of the first pixel at the first planar image can be obtained.

In Formulas 1-10, “scale” means scaling a value, and a value of scale in each formula can be the same.

A manner of determining at least one second region for the first region is described above, i.e., determining a mapping position at the first planar image for a region included in the second planar image, and determining a region whose mapping position falls within the first region as the second region. Therefore, various regions of the second planar image need to be mapped to the first planar image. However, the embodiments of the present disclosure are not limited to this manner. Another implementation manner will be described below.

In another implementation manner, a mapping position of the first region at the second planar image can be determined, and a region where the mapping position of the first region falls at the second planar image is determined as the second region corresponding to the first region.

In some embodiments, each of various second planar images that are stitched to form a curved surface image can be divided into multiple regions, and the first planar image can be divided into multiple regions. When a motion vector of a certain region of the first planar image needs to be calculated, a position where the certain region falls at the second planar image can be calculated, and the regions at the second planar image where the certain region falls in can be determined as the second regions corresponding to the certain region.

The first region falling in the second region may refer to that the entire or some of the pixels included fall in the second region. A first region can fall in one second planar image, or fall in multiple second planar images.

In some embodiments, a mapping position at the second planar image for a first pixel at a first region is determined, and a mapping position at the second planer image for the first region is determined according to the mapping position of the first pixel at the second planar image.

The first pixel may include a center pixel of the first region, or another pixel of the first region. For example, if the first region is a square region, the first pixel may include pixels at four vertices of the square.

After the mapping positions of one or more first pixels at the second planar image are calculated, the mapping position of the first region at the second planar image can be determined according to a shape of the first region.

In some embodiments, the mapping position of the first pixel at the second planar image can be calculated by mapping the coordinates of the first pixel at the first planar image to spherical coordinates and mapping the spherical coordinates to the coordinates at the second planar image.

In some embodiments, according to a rotation matrix that is used to rotate and stitch the second planar images to obtain the curved surface image, and/or an intrinsic parameter matrix of a camera that shoots the second planar image, the mapping position of the first pixel at the second planar image is determined. For calculation formulas, a reference can be made to the above Formulas 1-10.

At 320, a motion vector of the first region is obtained according to a motion vector of the at least one second region.

In some embodiments, the motion vector of the second region may be generated by the ISP end.

In some embodiments, the motion-compensated temporal filtering (MCTF) technology at the ISP end can use motion estimation compensation and one-dimensional time-domain decomposition technology to remove redundant information between frames. When the motion-compensated temporal filtering is performed, a motion estimation in a pixel domain is performed and a motion vector is determined through a block matching method. The motion vector can be used for inter prediction in video coding.

In some embodiments, the first region may include at least one sub-region, and a motion vector of a sub-region is calculated according to motion vectors of the second regions whose mapping positions fall in the sub-region. The motion vector of the first region is calculated according to the motion vector of the at least one sub-region.

In some embodiments, the first region is divided into at least one sub-region according to the mapping position of the at least one second region at the first region.

In some embodiments, because the first region is formed by stitching at least one second region, different second regions may be mapped to different positions of the first region, and the corresponding motion vectors of different second regions may also be different. Therefore, the first region can be divided into sub-regions based on the mapping position of at least one second region at the first region, and the motion vectors of various sub-regions can be calculated separately. Further, the motion vector of the first region can be calculated according to the motion vectors of various sub-regions, thereby improving a calculation accuracy of the motion vector.

In some embodiments, one or more second regions are mapped to one sub-region. When multiple second regions are mapped to one sub-region, the numbers of pixels of the multiple second regions in the one sub-region are the same as each other.

A second region mapping to one sub-region may refer to that all pixels or some pixels of the second region are mapped to the one sub-region. One second region may fall in different sub-regions.

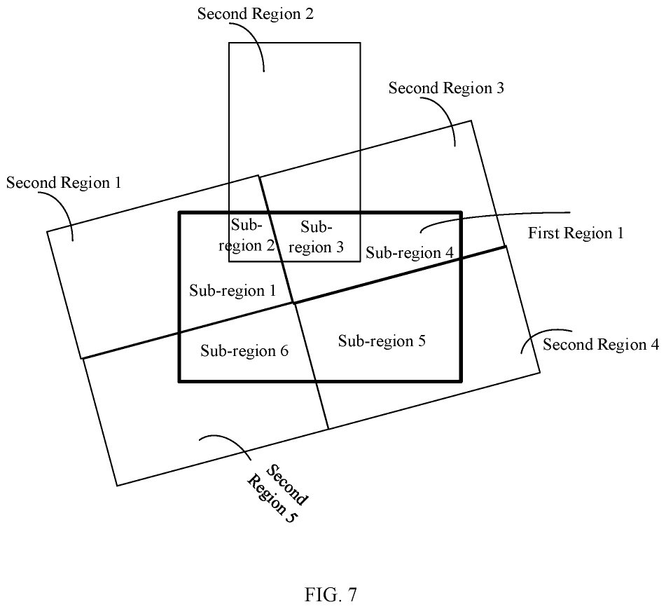

For example, as shown in FIG. 7, there are multiple rectangular second regions, i.e., second region 1, second region 2, second region 3, second region 4, and second region 5 whose mapping positions fall in a rectangular first region 1. First region 1 is divided into multiple sub-regions according to mapping positions of the multiple second regions at first region 1, i.e., sub-region 1, sub-region 2, sub-region 3, sub-region 4, sub-region 5, and sub-region 6. Second region 1 is mapped into sub-region 1, second region 1 and second region 2 are mapped into sub-region 2, second region 2 and second region 3 are mapped into sub-region 3, second region 3 is mapped into sub-region 4, second region 4 is mapped into sub-region 5, and second region 5 is mapped into sub-region 6.

In some embodiments, the motion vector of a sub-region is determined according to the motion vector(s) of the second region(s) whose mapping position(s) fall in the sub-region.

In some embodiments, the motion vector of a sub-region can be determined according to the motion vector(s) of the second region(s) whose mapping position(s) fall in the sub-region and a first value as a weighting factor. The first value is equal to a ratio of a number of pixels included in the sub-region to a total number of pixels included in the first region.

In some embodiments, a sum of the motion vectors of the at least one sub-region is used as the motion vector of the first region.

For example, the first region is obtained by mapping n second regions, where n is a positive integer. GMV information of an i-th region of the n second regions is GMVᵢ (i=1, 2, 3, . . . , n). A ratio of an area of the second region to an area of the current first region is calculated and used as a weighting factor Wᵢ for calculating the GMV information. The weighting factor of the second region is calculated by calculating a ratio of a number of pixels contained in the second region and a number of pixels contained in the current first region. Then the GMV of the current first region can be calculated using Formula 11 below.

$${GMV}_{i} = {\sum }_{i = 1}^{n} {GMV}_{i} * {W}_{i} \qquad Formula 11$$

In the above-described example, the motion vector of the first region is calculated according to the motion vectors of the second regions and the weighting factors corresponding to the second regions. In this example, there is no problem of mapping overlap. That is, there is no pixel at the first region into which pixels from multiple second regions are mapped. In this scenario, different second regions correspond to different sub-regions of the first region.

In some embodiments, when mapping positions of multiple second regions fall in a same sub-region, the motion vectors of the multiple second regions are averaged and the motion vector of the sub-region is calculated according to an average motion vector.

For example, as shown in FIG. 7, second region 1 and second region 2 are mapped into sub-region 2. The motion vectors of second region 1 and second region 2 can be averaged, and the motion vector of sub-region 2 is calculated according to the average motion vector and a weighting factor, which is a ratio of the number of pixels contained in sub-region 2 to the number of pixels contained in first region 1.

In some embodiments, a sub-region may include one or more pixels. When a sub-region includes one pixel, the motion vectors of various pixels can be calculated separately, and then the motion vector of the first region can be calculated based on the motion vectors of various pixels.

In some embodiments, the motion vector of the second region is corrected according to the rotation matrix that is used to rotate and stitch the second planar image to obtain the curved surface image.

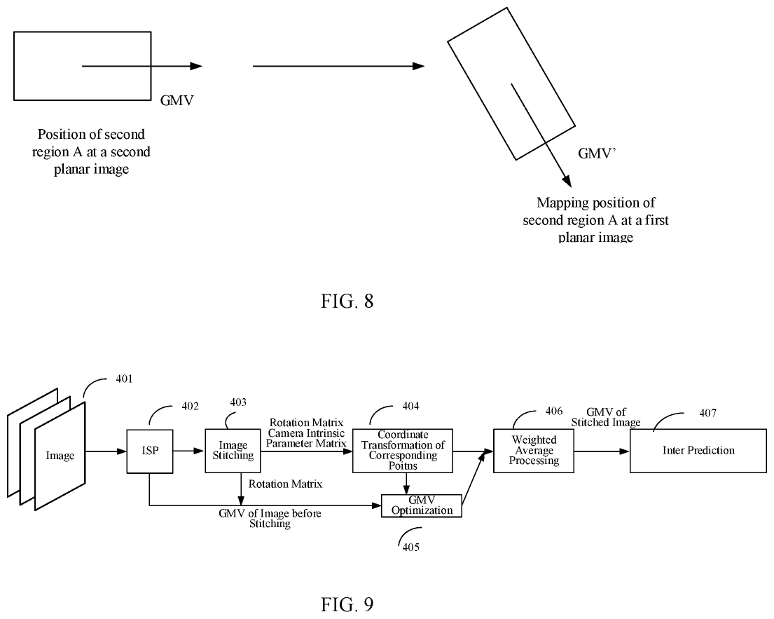

In some embodiments, a process of stitching at least one second planar image to form the curved image may involve a rotation of the second planar image, and the rotation process may affect the motion vector. As shown in FIG. 8, relative to a position of second region A at the second planar image, a mapping position of second region A at the first planar image is a position after a rotation, so a corresponding motion vector can also be rotated. The rotation matrix can be used for correcting the GMV information of the second region. It is assumed that a GMV of second region A before correction is (x, y), a GMV after the rotation correction is (x′, y′), z=1, and the rotation matrix is R. The corrected motion vector can be obtained using Formulas 12-14 below.

$$\begin{matrix}[ \begin{matrix}{x}^{″} \\ {y}^{″} \\ {z}^{″}\end{matrix} ] = R * [ \begin{matrix}x \\ y \\ z\end{matrix} ] & Formula 12 \\ {x}^{′} = \frac{{x}^{″}}{{z}^{″}} & Formula 13 \\ {y}^{′} = \frac{{y}^{″}}{{z}^{″}} & Formula 14\end{matrix}$$

At 330, the first planar image is encoded by using the motion vector of the at least one first region included in the first planar image.

In some embodiments, an inter prediction is performed on the first region according to the motion vector of the first region.

In some embodiments, reference data used in the inter prediction of the first region is obtained according to the motion vector of the first region.

In some embodiments, a motion search may be performed according to the motion vector of the first region to obtain a motion vector used for inter prediction. The reference data used in the inter prediction of the first region is obtained according to the obtained motion vector for inter prediction.

In some embodiments, after the motion vector of the first region is obtained, a search origin may be determined based on the motion vector, the motion search may be performed to obtain the motion vector for inter prediction, and thus the reference data may be obtained according to the motion vector. Further, a pixel residual can be obtained according to the reference data.

FIG. 9 is a schematic flowchart of an image processing method according to an embodiment of the present disclosure.

At 401, a plurality of planar images are input to an ISP.

At 402, the ISP obtains GMVs of various regions at various planar images.

At 403, an image stitching is performed on the plurality of planar images to obtain a stitched curved surface image, and the stitched curved surface image is mapped to obtain a stitched planar image.

At 404, a camera intrinsic parameter matrix and a rotation matrix used in the image stitching and mapping process are used to perform a coordinate transformation of a corresponding position to determine a mapping position of a region of a planar image before stitching at a region of the stitched image.

At 405, a GMV of a region of the image before stitching is optimized.

At 406, weighted averaging is performed on the optimized GMVs of the regions of the image before stitching to obtain a GMV of the stitched planar image.

At 407, the GMV obtained at process 406 is used to perform inter prediction.

For implementation manners of various processes of the image processing method shown in FIG. 9, a reference can be made to the above description, which is not repeated here.

In the embodiments of the present disclosure, the first planar image is obtained by mapping the curved surface image, and the curved surface image is obtained from the second planar image. The second planar image is an image from which the curved surface image is obtained. Therefore, the second planar image has not been stretched and distorted, and a corresponding motion is still a rigid motion. Using the motion vector of the region at the second planar image to determine the motion vector of the region at the first planar image can avoid an inaccurate motion vector caused by directly using the stretched and distorted first planar image to calculate the motion vector, thereby further improving the coding quality.

Further, in the embodiments of the present disclosure, the motion vector of the region of the first planar image is first obtained, and then the encoding is performed on the first planar image, which can avoid a problem of high complexity caused by encoding the video first to obtain the motion vector, and then calculating the motion vector for encoding the video for a second time. Furthermore, in the embodiments of the present disclosure, the motion vector is calculated by using images that are used for obtaining the current frame image, and then the motion vector is used for encoding the current frame image, which can avoid using the motion vector calculated using the encoding information of other frame images for encoding the current frame image, and further avoid the problem of inaccurate motion vector calculation, thereby further improving the coding quality.

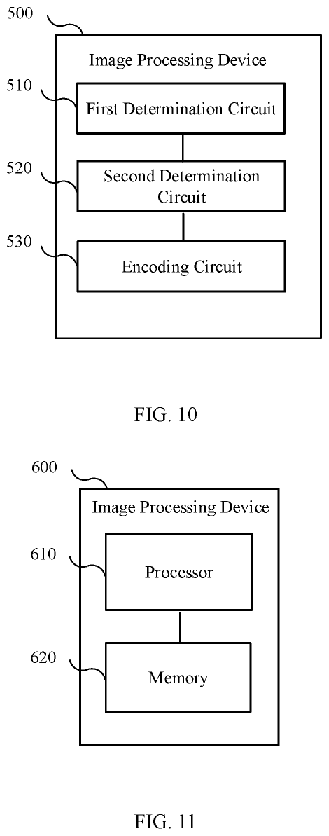

FIG. 10 is a schematic block diagram of an image processing device 500 according to an embodiment of the present disclosure. As shown in FIG. 10, the device 500 includes a first determination circuit 510, a second determination circuit 520, and an encoding circuit 530.

The first determination circuit 510 is configured to determine at least one second region for obtaining a first region at a first planar image. The second region is a region at a second planar image. The first planar image is obtained by mapping a curved surface image and the curved surface image is obtained from at least one second planar image. The second determination circuit 520 is configured to obtain a motion vector of the first region according to a motion vector of the at least one second region. The encoding circuit 530 is configured to encode the first planar image by using the motion vector of the at least one first region included in the first planar image.

In some embodiments, the first region is obtained by stitching the at least one second regions.

In some embodiments, the first determination circuit 510 is configured to determine a mapping position at the first planar image for a region included in the second planar image and determine, among the regions included in the second planar image, a region whose mapping position falls within the first region as the second region.

In some embodiments, the first determination circuit 510 is configured to determine a mapping position at the first planar image for a first pixel in a region included in the second planar image and determine a mapping position at the first planer image for the region included in the second planar image according to the mapping position of the first pixel at the first planar image.

In some embodiments, the first determination circuit 510 is configured to map the coordinates of the first pixel at the second planar image to spherical coordinates and map the spherical coordinates to the coordinates at the first planar image.

In some embodiments, the first determination circuit 510 is configured to determine the mapping position of the first pixel at the first planar image according to a rotation matrix that is used to rotate and stitch the second planar images and/or an intrinsic parameter matrix of a camera that shoots the second planar image.

In some embodiments, the first pixel includes a center pixel

In some embodiments, the first region may include at least one sub-region, and the second determination circuit 520 is configured to calculate a motion vector of the sub-region according to motion vectors of the second regions whose mapping positions fall in the sub-region, and calculate a motion vector of the first region according to the motion vector of the at least one sub-region.

In some embodiments, one or more second regions are mapped to one sub-region. When multiple second regions are mapped to one sub-region, the numbers of pixels of the multiple second regions in the one sub-region are the same as each other.

In some embodiments, the second determination circuit 520 is configured to determine the motion vector of the sub-region according to the motion vector(s) of the second region(s) whose mapping position(s) fall in the sub-region and a first value as a weighting factor. The first value is equal to a ratio of a number of pixels included in the sub-region to a total number of pixels included in the first region.

In some embodiments, the second determination circuit 520 is configured to use a sum of the motion vectors of the at least one sub-region as the motion vector of the first region.

In some embodiments, the at least one sub-region includes a first sub-region, and the second determination circuit 520 is configured to average the motion vectors of the multiple second regions when mapping positions of multiple second regions fall in the sane sub-region and calculate a motion vector of the same sub-region according to an average motion vector.

In some embodiments, the second determination circuit 520 is configured to correct the motion vector of the second region according to the rotation matrix that is used to rotate and stitch the second planar image to obtain the curved surface image.

In some embodiments, the second determination circuit 520 is configured to determine the motion vector of the first region according to the motion vector of the at least one second region generated by an ISP.

In some embodiments, the motion vector is a GMV.

In some embodiments, the first planar image is obtained by mapping the curved surface image to a plurality of polygons on a surface of a polyhedron and expanding the plurality of polygons.

In some embodiments, the first planar image is obtained by mapping the curved surface image according to a manner of a two-dimensional latitude and longitude map.

In some embodiments, the encoding circuit 530 is configured to perform an inter prediction on the first region according to the motion vector of the first region.

In some embodiments, the encoding circuit 530 is configured to perform a motion search according to the motion vector of the first region to obtain a motion vector used for inter prediction, and obtain reference data used in the inter prediction of the first region according to the obtained motion vector for inter prediction.

In some embodiments, the first determination circuit 510, the second determination circuit 520, and the encoding circuit 530 may all be implemented by an encoder, or may be implemented separately. For example, the first determination circuit 510 and the second determination circuit 520 are implemented by a processing device other than an encoder, and the encoding circuit 530 is implemented by an encoder.

The image processing device in the foregoing embodiments of the present disclosure may be a chip, which may be implemented by a circuit. The implementation manner is not limited in the embodiments of the present disclosure.

FIG. 11 is a schematic block diagram of a computer system 600 according to an embodiment of the present disclosure.

As shown in FIG. 11, the computer system 600 may include a processor 610 and a memory 620.

The computer system 600 may also include components commonly included in other computer systems, such as input and output devices, communication interfaces, etc., which are not limited in the embodiments of the present disclosure.

The memory 620 is used to store computer executable instructions.

The memory 620 may be various types of memories, for example, it may include a high-speed random access memory (RAM), and may also include a non-volatile memory such as at least one disk memory, which is not limited in the embodiments of the present disclosure.

The processor 610 is configured to access the memory 620 and execute the computer-executable instructions to perform operations in the image processing method in the above-described embodiments of the present disclosure.

The processor 610 may include a microprocessor, a field-programmable gate array (FPGA), a central processing unit (CPU), or a graphics processing unit (GPU), etc., which is not limited in the embodiments of the present disclosure.

The image processing device and the computer system of the embodiments of the present disclosure may correspond to the execution subject of the image processing method of the embodiments of the present disclosure, and the above-described and other operations and/or functions of each module in the image processing device and the computer system are respectively intended to realize the foregoing corresponding processes of the methods, which is not repeated here.

An electronic device is also provided according to an embodiment of the present disclosure and the electronic device may include the image processing device or the computer system of the foregoing embodiments of the present disclosure.

A computer storage medium is also provided according to an embodiment of the present disclosure and the computer storage medium stores program codes. The program codes may be used to instruct the execution of the image processing method described in the foregoing embodiments of the present disclosure.

The term “and/or” in this disclosure is merely an association relationship describing the associated objects and indicates that there may be three relationships. For example, A and/or B may indicate three cases such as only A existing, both A and B existing, and only B existing. In addition, the character “1” in this disclosure generally indicates that the related objects before and after are in an “or” relationship.

Those of ordinary skills in the art may realize that the units and algorithms described in the embodiments of the disclosure can be implemented by electronic hardware, or a combination of computer software and electronic hardware. Whether these functions are executed in hardware or software depends on the specific application of the technical solution and design constraints. Professional technicians can use different methods to implement the described functions for each specific application, but such implementation should not be considered beyond the scope of this disclosure.

Those of ordinary skills in the art can clearly understand that for the convenience and conciseness of the description, for the specific working process of the system, device and unit described above, reference can be made to the corresponding process in the foregoing method embodiments, which will not be repeated here.

In the embodiments provided in this disclosure, the disclosed system, device, and method may be implemented in other ways. For example, the device embodiments described above are only schematic. For example, the division of the units is only a division of logical functions. In actual implementation, there may be other divisions, for example, multiple units or components may be combined or integrated into another system, or some features may be ignored or not implemented. In addition, the displayed or discussed mutual coupling or direct coupling or communication connection may be indirect coupling or communication connection through some interfaces, devices or units, and may be in electrical, mechanical or other forms.

The units described as separate components may or may not be physically separated, and the components displayed as units may or may not be physical units. That is, they may be located in one place or may be distributed on multiple network units. Some or all of the units may be selected according to actual needs to achieve the purpose of the solution of this embodiment.

In addition, each functional unit in each embodiment of the present disclosure may be integrated into one processing unit, or each unit may exist alone physically, or two or more units are integrated into one unit. The integrated unit can be implemented in a form of hardware or software functional unit.

If the integrated unit is implemented in the form of a software functional unit and sold or used as an independent product, it can be stored in a computer readable storage medium. Based on this understanding, a part of the technical solution of the present disclosure that is essentially contributes to the existing technology, or all or part of the technical solution can be embodied in the form of a software product. The computer software product is stored in a storage medium and includes several instructions to cause a computer device (which may be a personal computer, a server, or a network device, etc.) to execute all or part of the processes of the method in the embodiments of the present disclosure. The aforementioned storage medium includes media that can store program codes, such as a U disk, a portable hard disk, a read-only memory (ROM), a random access memory (RAM), a magnetic disk or an optical disk, etc.

The above is only the specific implementations of this disclosure, but the scope of this disclosure is not limited to this. Any person skilled in the art can easily think of changes or replacements within the technical scope disclosed in this disclosure, which should be covered by the scope of this disclosure. Therefore, the scope of the invention shall be subject to the scope of the claims.

1. An image processing method comprising:
for a first region in a first planar image, determining a second region for obtaining the first region, the second region being a region in a second planar image, the first planar image being obtained by performing mapping on a curved surface image, and the curved surface image being obtained from the second planar image;
obtaining a motion vector of the first region at least according to a motion vector of the second region; and
encoding the first planar image at least according to the motion vector of the first region.

2. The method of claim 1, wherein the second region is one of a plurality of second regions corresponding to the first region, and the first region is obtained by stitching the plurality of second regions.

3. The method of claim 2, wherein determining the second region for obtaining the first region includes:
determining a mapping position of a candidate region in the first planar image, the candidate region being a region in the second planar image; and
in response to the mapping position of the candidate region falling within the first region, determining the candidate region as the second region.

4. The method of claim 3, wherein determining the mapping position of the candidate region includes:
determining a mapping position of a pixel of the candidate region in the first planar image; and
determining the mapping position of the candidate region according to the mapping position of the pixel.

5. The method of claim 4, wherein determining the mapping position of the pixel includes:
mapping coordinates of the pixel in the second planar image to spherical coordinates; and
mapping the spherical coordinates to coordinates in the first planar image.

6. The method of claim 4, wherein determining the mapping position of the pixel includes:
determining the mapping position of the pixel according to at least one of a rotation matrix that is used to rotate and stitch the second planar image or an intrinsic parameter matrix of a camera that captures the second planar image.

7. The method of claim 1, wherein:
the first region includes a sub-region;
a mapping position of the second region in the first planar image falls in the sub-region; and
obtaining the motion vector of the first region includes:
calculating a motion vector of the sub-region at least according to the motion vector of the second region; and
calculating the motion vector of the first region according to at least the motion vector of the sub-region.

8. The method of claim 7, wherein:
the second region is one of a plurality of second regions that are mapped to the sub-region; and
a number of pixels of one of the plurality of second regions is same as a number of pixels of another one of the plurality of second regions.

9. The method of claim 7, wherein calculating the motion vector of the sub-region includes:
determining the motion vector of the sub-region at least according to the motion vector of the second region and a weighting factor, the weighting factor being equal to a ratio of a number of pixels included in the sub-region to a total number of pixels included in the first region.

10. The method of claim 7, wherein:
the sub-region is one of a plurality of sub-regions of the first region; and
calculating the motion vector of the first region at least according to the motion vector of the sub-region includes calculating a sum of the motion vectors of the plurality of sub-regions as the motion vector of the first region.

11. The method of claim 7, wherein:
the second region is one of a plurality of second regions that are mapped to the sub-region; and
calculating the motion vector of the sub-region includes:
averaging the motion vectors of the plurality of second regions to obtain an average motion vector; and
calculating the motion vector of the sub-region according to the average motion vector.

12. The method of claim 1, further comprising:
correcting the motion vector of the second region according to a rotation matrix that is used to rotate and stitch the second planar image to obtain the curved surface image.

13. The method of claim 1, further comprising:
generating the motion vector of the second region with aid of an image signal processor.

14. The method of claim 1, wherein the motion vector of the second region includes a global motion vector (GMV) of the second region, and the motion vector of the first region includes a GMV of the first region.

15. The method of claim 1, further comprising:
mapping the curved surface image to a plurality of polygons on a surface of a polyhedron; and
expanding the plurality of polygons to obtain the first planar image.

16. The method of claim 1, further comprising:
performing mapping on the curved surface image according to a manner of a two-dimensional latitude and longitude map to obtain the first planar image.

17. The method of claim 1, wherein encoding the first planar image includes:
performing an inter prediction on the first region according to the motion vector of the first region.

18. The method of claim 17, wherein performing the inter prediction on the first region includes:
performing a motion search according to the motion vector of the first region to obtain a motion vector used for inter prediction; and
obtaining reference data used in the inter prediction for the first region according to the obtained motion vector for inter prediction.

19. An image processing device comprising:
a processor; and
a memory storing instructions that, when executed by the processor, cause the processor to:
for a first region in a first planar image, determine a second region for obtaining the first region, the second region being a region in a second planar image, the first planar image being obtained by performing mapping on a curved surface image, and the curved surface image being obtained from at least the second planar image;
obtain a motion vector of the first region at least according to a motion vector of the second region; and
encode the first planar image at least according to the motion vector of the first region.

20. The device of claim 19, wherein the second region is one of a plurality of second regions corresponding to the first region, and the first region is obtained by stitching the plurality of second regions.
